(19) United States
(12) Patent Application Publication
(10) Pub. No.: US 2009/0210489 A1
(43) Pub. Date: Aug. 20, 2009

(54) METHODS FOR PEER-CACHING FOR FASTER LOOKUPS IN PEER-TO-PEER SYSTEMS

(76) Inventors: Supratim Deb, Bangalore (IN); Rajeev Rastogi, Bangalore (IN); Anand Srinivasan, Bangalore (IN); Prakash Linga, San Carlos, CA (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/032,755

(22) Filed: Feb. 18, 2008

(51) Int. Cl. G06F 15/16

(52) U.S. Cl. 709/204

(57) ABSTRACT

The invention improves query response latency in a peer-to-peer network. The invention augments core neighbors included in a neighbor list of a peer node by selecting auxiliary neighbors for inclusion in the neighbor list of the peer node of a peer-to-peer network. In one embodiment, a method includes maintaining query frequency information associated with each of a plurality of peer nodes of the peer-to-peer network, selecting at least one of the peer nodes of the peer-to-peer network as an auxiliary neighbor using the query frequency information, and updating a neighbor list to include the at least one peer node selected as the at least one auxiliary neighbor. The core neighbors stored at a peer node attempt to minimize the worst-case query latency for that peer node. The auxiliary neighbors stored at the peer node attempt to reduce the average query latency for that peer node. The auxiliary neighbors may be used in any peer-to-peer system, such as Pastry, Tapestry, Chord, SkipGraph, and the like.

### FIELD OF THE INVENTION

The invention relates to the field of communication networks and, more specifically, to peer-to-peer networks.

### BACKGROUND OF THE INVENTION

A peer-to-peer (P2P) network is a network of interconnected nodes having diverse connectivity and, thus, is an efficient means of providing large-scale, distributed information storage and retrieval (e.g., for sharing data, audio, video, and the like). A P2P network may be unstructured or structured. A majority of structured P2P networks are implemented as distributed hash tables (DHTs), which are typically highly scalable and support efficient, low-latency queries (i.e., search and retrieval of data). Disadvantageously, however, many applications which may utilize P2P networks (e.g., naming services) require lower lookup latencies than can be supported by DHTs. There have been attempts to improve query times of P2P networks, however, such attempts have disadvantages.

A first attempt to improve item lookup times of P2P systems is “Beehive”, an item replication scheme where replication is expressed as an optimization problem that takes into account the trade-off between overhead of maintaining replicas and performance improvements. The Beehive approach, however, results in an unacceptable update overhead (e.g., since popular items are replicated more, the overhead of keeping the replicas updated is larger). A second attempt to improve item lookup times of P2P systems is “EpiChord”, a variant of “Chord” (a popular P2P system), in which a cache of all known nodes is maintained and the nodes are classified into different slices depending on distance. The EpiChord approach, however, does not place any restriction on the number of node pointers that may be cached.

### SUMMARY OF THE INVENTION

Various deficiencies in the prior art are addressed through invention of a method and apparatus for improving query response latency in a peer-to-peer network. The invention augments core neighbors included in a neighbor list of a peer node by selecting auxiliary neighbors for inclusion in the neighbor list of the peer node of a peer-to-peer network. In one embodiment, a method includes maintaining query frequency information associated with each of a plurality of peer nodes of the peer-to-peer network, selecting at least one of the peer nodes of the peer-to-peer network as an auxiliary neighbor using the query frequency information, and updating a neighbor list to include the at least one peer node selected as the at least one auxiliary neighbor. The core neighbors stored at a peer node attempt to minimize the worst-case query latency for that peer node. The auxiliary neighbors stored at the peer node attempt to reduce the average query latency for that peer node. The auxiliary neighbors may be used in any peer-to-peer system, such as Pastry, Tapestry, Chord, SkipGraph, and the like.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an exemplary peer-to-peer communication network;

FIG. 2 depicts a method according to one embodiment of the present invention;

FIG. 3 depicts an exemplary trie adapted for use in selecting a set of peer nodes for use as auxiliary neighbors in Pastry-based and Chord-based peer-to-peer networks; and

FIG. 4 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention provides a technique for minimizing average query latency by caching auxiliary neighbors at each of the nodes of a peer-to-peer network (in addition to the core neighbors typically cached at each of the nodes). The core neighbors cached at each peer node of the P2P network are determined based on the underlying P2P network. The auxiliary neighbors cached at each peer node of the P2P network are determined based on access frequency information associated with each of the other peer nodes of the P2P network. For each peer node of the P2P network, while the core neighbors stored at that node attempt to minimize the worst-case query latency for that node, the auxiliary neighbors stored at that node attempt to reduce the average query latency for that node.

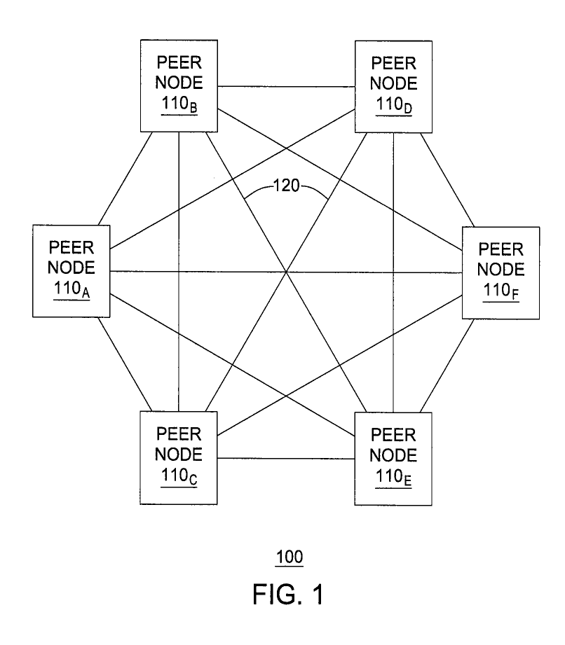

FIG. 1 depicts a high-level block diagram of an exemplary peer-to-peer (P2P) network. Specifically, peer-to-peer network 100 includes a plurality of peer nodes 110_{A}-110_{F} (collectively, peer nodes 110). The peer nodes 110 communicate using a plurality of communication paths 120 (collectively, communication paths 120). The peer-to-peer network 100 operates as an overlay network, such that communications paths 120 between peer nodes 110 may traverse any other physical nodes and physical links (i.e., using any means of providing connectivity between peer nodes 110).

In peer-to-peer network 100, each of the peer nodes 110 stores items. The peer nodes 110 are each responsible for a set of items. The peer-to-peer network 100 supports a protocol for routing queries for items between peer nodes 110. In general, a design objective is to have each of the peer nodes 110 store pointers to a subset of the other peer nodes 110 such that a query for an item reaches the destination peer node (i.e., the peer node 110 that stores the requested item) with the fewest number of hops (i.e., in order to be able to serve each request for an item as quickly as possible).

The peer nodes 110 may be any type of nodes which may be connected to form a peer-to-peer network. The peer nodes 110 may vary by application. For example, nodes 110 may include network servers (e.g., DNS servers, AAA servers, and the like), content servers (e.g., IPTV servers, VOD servers, and the like), and the like. The type of items stored by peer nodes 110 vary by applications. For example, where peer nodes 110 are DNS servers, the items may be addresses. For example, where peer nodes 110 are VOD servers, the items may be videos (e.g., episodes of television programs, movies, and the like).

The communication paths 120 may be any type of communication paths which may facilitate communication between peer nodes of a peer-to-peer network. For example, the communication paths 120 may utilize any communications networks (e.g., public networks, private networks, and the like, as well as various combinations thereof). For example, communication paths 120 may utilize any underlying communications technologies (e.g., any physical layer technologies, any data link layer technologies, any network layer technologies, any transport layer technologies, and the like, as well as various combinations thereof).

The peer nodes 110 may communicate for performing different functions (e.g., for responding to query requests, for routing a query requests between peer nodes 110 until the query requests are served by the destination peer node, and the like, as well as various combinations thereof). The peer nodes 110 may communicate using any communication protocol(s) capable of supporting communications of a peer-to-peer network. For example, the peer nodes 110 may communicate using one or more peer-to-peer protocols, such as Pastry, Tapestry, Chord, SkipGraph, and the like. The peer nodes 110 may communicate using any other peer-to-peer protocols.

As peer-to-peer network 100 functions, each of the peer nodes 110 receive query requests for information stored within peer-to-peer network 100. A peer node 110 that receives a query request may either serve the query request locally (if the requested information is stored on that peer node), or direct the query request to one of the other peer nodes 110 (which may either serve the query request for forward the query request in a similar fashion). In this manner, as long as one of the peer nodes 110 stores the requested information, the query request will eventually be served.

As described herein, if a target peer node 110 cannot serve a query request locally (i.e., the target peer node 110 is not the destination node for the requested item), the target peer node 110 forwards the request to one of the other peer nodes 110. In order for the target peer node 110 to forward the query request to one of the other peer nodes 110, the target peer node 110 must select one of the other peer nodes 110 to which the query request should be forwarded. The target peer node 110 typically selects one of the other peer nodes 110 using a routing table (also referred to herein as a neighbor list) maintained on the target peer node 110.

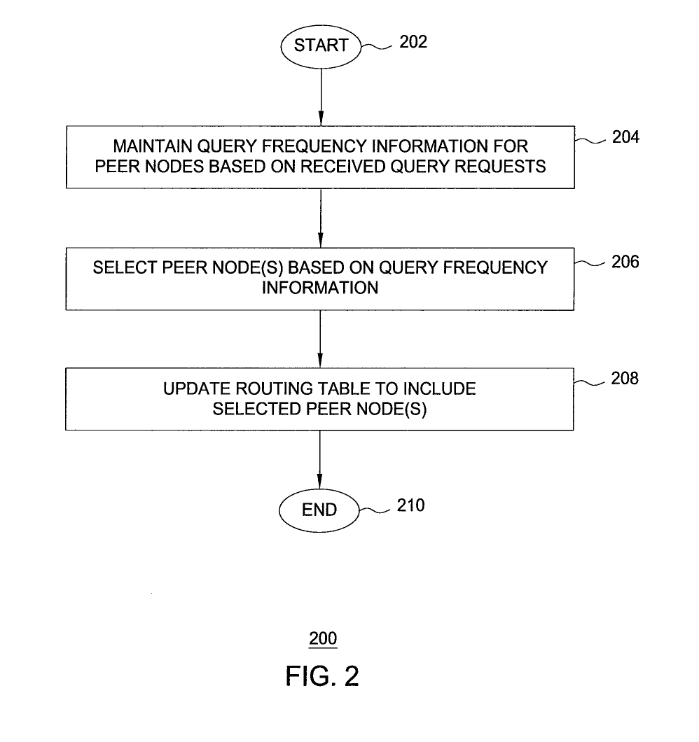

In existing peer-to-peer networks, the routing table that is maintained at each peer node includes a list of core neighbors. The present invention augments the core neighbors of the routing table with at least one auxiliary neighbor selected for inclusion in the routing table. The at least one auxiliary neighbor is selected for inclusion in the routing table of a peer node based on access frequency information associated with other peer nodes of the peer-to-peer network. A method for augmenting the routing table of a peer node to include auxiliary neighbors is depicted and described herein with respect to FIG. 2.

FIG. 2 depicts a method according to one embodiment of the present invention. Specifically, method 200 of FIG. 2 includes a method for selecting auxiliary neighbors for inclusion in a routing table of a target peer node of a peer-to-peer network (to augment core neighbors included in the routing table). The target peer node is a peer node on which method 200 is executed. Although depicted and described as being performed serially, at least a portion of the steps of method 200 may be performed contemporaneously, or in a different order than depicted and described with respect to FIG. 2. The method 200 begins at step 202 and proceeds to step 204.

At step 204, query frequency information is maintained. The query frequency information is maintained at the target peer node. The query frequency information is maintained based on query requests received at the target peer node from other peer nodes of the peer-to-peer network. The query requests used for maintaining the query frequency information may include any query requests received at the target node (e.g., using query requests that the target node forwards to other peer nodes, and the like). The query frequency information may be maintained by receiving query requests, determining information from the received query requests, storing information, and any other functions which may be used to maintain query frequency information.

The query frequency information may be determined in any manner. In one embodiment, query request statistics may be logged at the target peer node as query requests are received from other peer nodes, and the query frequency information may be determined by processing the query request statistics (e.g., computing query frequency values based on the number of query requests logged and the length of time over which the query requests were logged). In one embodiment, query frequency values may be maintained for each of the peer nodes and updated as the query requests are received (e.g., updating query frequency values for peer nodes as query requests are received from the peer nodes). The query frequency information may be maintained in any other manner.

The query frequency information may be stored and updated in any manner. In one embodiment, query frequency information may be stored at the target peer node using a query frequency table. In one such embodiment, the query frequency table may include an entry for each of the other peer nodes, where the entry includes an identifier of the peer node and a query frequency value for the peer node (e.g., x number of queries within y length of time). In one embodiment, the query frequency information may be stored as a series of query frequency values for each of the other peer nodes. The query frequency information may be stored and/or updated in any other manner.

At step 206, a set of k peer nodes is selected (k≧1). The set of k peer nodes is selected based on the query frequency information maintained for the peer nodes. The set of k peer nodes includes peer node(s) selected for use as auxiliary neighbor(s) in the routing table of the target peer node (i.e., to supplement core neighbors already included in the routing table of the target peer node). The peer nodes included in the set of k peer nodes selected as auxiliary neighbors may be selected in any manner.

In one embodiment, the peer nodes included in the set of k peer nodes that are selected as auxiliary neighbors may be selected in a manner tending to minimize the average query latency for the target peer node. In one embodiment, the manner in which the set of k peer nodes is selected for use as auxiliary neighbors may vary based on the implementation of the peer-to-peer network (e.g., auxiliary neighbor selection algorithms may be different for Pastry, Chord, and other peer-to-peer implementations). The selection of auxiliary neighbors in Pastry-based and Chord-based implementations of peer-to-peer networks are depicted and described in additional detail herein.

At step 208, the routing table is updated to include the set of k peer nodes selected as auxiliary neighbors. The routing table may be updated to include the selected set of k peer node in any manner. In one embodiment, for example, in which the routing table does not include any auxiliary neighbors, the routing table is updated by adding, to the routing table, a pointer to each peer node selected as an auxiliary neighbor (i.e., each of the k selected peer nodes). In another embodiment, for example, in which the routing table does include auxiliary neighbors, the routing table is updated by removing pointers to peer nodes no longer selected as auxiliary neighbors and adding pointers to peer nodes newly selected as auxiliary neighbors. The routing table may be updated in any other manner.

At step 210, method 200 ends. Although depicted and described as ending (for purposes of clarity), method 200 may be repeated. For example, method 200 may be repeated periodically, repeated a periodically in response to an event (e.g., a change in the query frequency statistics, addition of a new peer node to the peer-to-peer network, removal of an existing peer node from the peer-to-peer network, or any other event or combination of events which may cause a change to optimum set of auxiliary neighbors for the target peer node), and the like, as well as various combinations thereof.

In general, there are two important components in the design of a P2P system, the design of the routing protocol and the choice of neighbor nodes to include in the routing table. These components may be designed in an attempt to improve query latency times (where latency is often measured in terms of the number of hops required to serve queries for items). In existing peer-to-peer systems, core neighbor nodes are selected to attempt to minimize the worst-case query latency; however, since the average query latency may vary widely depending on the population distribution of the peer nodes, selection of core neighbors does not improve average query latency times.

The present invention reduces the average query latency for a peer node by selecting additional neighbor nodes for inclusion in the routing table of the target peer node, where selection of auxiliary neighbors is based on query frequency information associated with other peer nodes of the P2P network. The selection of peer nodes for use as auxiliary nodes may be better understood with respect to the following description of peer-to-peer systems in general, and more specifically, with respect to the following description of auxiliary node selection algorithms which may be implemented within Pastry-based and Chord-based systems.

In selecting auxiliary neighbors for inclusion in the routing table of a peer node, it should be noted the number of neighbor nodes maintained in a routing table of a peer node is directly related to the maintenance cost induced by peer nodes joining and leaving the P2P system. In other words, the size of the routing table of a peer node needs to be balanced against the cost of maintaining that routing table at the peer node. For example, the maintenance cost consists of overhead messages used to ensure that all of the entries of the routing table point to live neighbors (important in the presence of churn). This cost may be incurred as nodes join and leave the P2P network, as nodes refresh their neighbor lists, and the like.

For example, a peer node may periodically ping the neighbor nodes included in its routing table in order to determine whether all of the neighbor nodes are still live (e.g., such that stale neighbors can be replaced with new neighbors). Additionally, for example, if churn is high, the refresh interval needs to be smaller to ensure that stale neighbors in the routing table do not result in unanswered queries. Thus, from these examples, it becomes clear that the maintenance cost of a routing table grows with the size of the routing table.

In one embodiment, selection of auxiliary neighbors may be performed for P2P systems using prefix-based routing (e.g., systems such as Pastry, Tapestry, and the like). In one embodiment, selection of auxiliary neighbors may be performed for P2P systems using small-world-like routing (e.g., systems such as Chord, SkipGraph, and the like). In such embodiments, selection of auxiliary neighbors may be performed using incremental algorithms adapted for selecting auxiliary neighbors in response to different events (e.g., when the access frequency of a peer node changes, when new peer nodes are added to the P2P network, and the like).

In general, Pastry is a self-organizing P2P system where each node in the Pastry overlay is assigned a b-bit identifier. The node identifier is used to indicate the location of the node in a circular identifier space ranging from 0 to 2^{b}-L. The node identifier is assigned randomly when a node joins. As a result, each node becomes responsible for a chunk of the identifier space. Furthermore, each item (e.g., a file, an audio clip, a movie, and the like) is also associated a unique identifier by hashing the content of the item into the identifier space. The identifier associated with the item is referred to herein as a key. The Pastry routing problem may be defined as follows: given a query at a node for an item with a given identifier, locate the node in the system that is responsible for the queried item. For the purpose of routing the queries, node identifiers and keys are viewed as a sequence of digits with base 2^{d} for some d. For purposes of clarity, assume that d=1 in the following paragraph.

In Pastry, in order to efficiently locate queried items, each node stores a few pointers to other nodes in its routing table. The table has a maximum of b rows, where the i^{th} (i=0,1, . . . , b−1) row contains the address (e.g., IP address) of some node that matches with the given node in the first i bits but differs in the (i+1)th bit. The uniform distribution of the node identifiers ensures that, with n nodes in the system, on average, only log n rows of the routing table have entries. In general, given such a routing table, routing operates as follows. Queries are routed to the node that is numerically closest to the queried key. At each step, a node forwards the query to a node whose identifier shares with the key a prefix that is at least one digit longer than the prefix that the key shares with the identifier of the present node. This procedure ensures that, in the steady state, queries are routed in log n hops. The Pastry protocol has several additional features to efficiently handle node joins and leaves.

In Chord, nodes and keys (i.e., the item identifiers) have identifiers structured in an identifier circle. For example, suppose the identifier lengths are b. A key k can be assigned to k's predecessor (i.e., the first node whose identifier is equal to k, or precedes k in the identifier space). Thus, a lookup for a key has to visit the key's predecessor, i.e., the node whose identifier most closely precedes the key. A node with identifier x in Chord keeps log n neighbors whose identifiers lie at exponentially increasing fractions of the identifier space away from itself. The node with the numerically smallest id among the ones with identifiers within the range from x+2ⁱ to x+2ⁱ⁺¹ (modulo 2^{b}) is used as the i^{th} neighbor of x. The Chord routing policy is the following: for a query with identifier v at x, the next hop is the neighbor of x that is closest to v and is between x and v in the clockwise direction on the ring. The choice of Chord pointers ensures that, with n nodes in the system, it takes a maximum of log n hops for the query to reach the destination (in the steady state). The Chord protocol has several additional features to efficiently handle node joins and leaves.

As described herein, a set of auxiliary neighbors (denoted herein as Aₛ) is selected and cached at each peer node (in addition to the set of core neighbors Nₛ) of the P2P network for minimizing average query latency of the peer-to-peer network. The auxiliary neighbors A_{S} may be selected in many ways, which may vary depending on the type of P2P network that is being implemented (e.g., Pastry, Chord, and the like). The exact problem of selecting the set of auxiliary neighbors Aₛ (as well as the terminology used in describing different auxiliary neighbor selection algorithms) may be defined as follows.

Let s be any node in the P2P network, and let Nₛ denote the set of core neighbors for node s. Let V (|V|=n) denote the set of nodes from which node s has received queries (not including s) and for which node s maintains query frequency statistics. As described herein, query frequency statistics may be easily maintained by node s in many ways (e.g., based on past history of queries received within a given time window, and the like). For each node v in V, assume binary identifiers of length b and a query frequency fᵥ. Although binary identifiers are assumed (for purposes of clarity), auxiliary neighbor selection algorithms described herein may be extended for embodiments in which the base is arbitrary.

Let dᵤᵥ denote the “distance” from node u to node v (e.g., in terms of number of hops). Since the computation is being done at node s, this distance is only an estimate of the actual distance between u and v. A simple estimate typically can be computed at node s based only on the identifiers of node u and node v and the underlying routing policy. This distance function is further described herein with respect to discussions of the routing policies of Pastry and Chord. Further, let d(u,S) denote the minimum distance between the node u and a set of nodes S, i.e., d(u,S)=min_{vεs}dᵤᵥ. Similarly, d(S,u)=min_{vεs}dᵥᵤ.

In one embodiment, given such definitions, the set of auxiliary neighbors Aₛ⊂V−Nₛ with IAₛI=k, may be selected in a manner for minimizing the following cost function:

$${A}_{s} {\sum }_{v} {f}_{v} ( 1 + d ( v , {N}_{s} ⋃ {A}_{s} ) ) .$$

In this embodiment, d(v,Nₛ U Aₛ) is an estimate of the minimum distance between node v and the neighbors (core and auxiliary) of node s. Thus, (1+d(v,Nₛ U Aₛ)) is the estimated distance of node v from node s taking into account the one hop from node s to its neighbor node. The term fᵥ(1+d(v,Nₛ U Aₛ)) is referred to herein as the weighted distance of node v. In one embodiment, the goal is to select a subset of V (of size k) as auxiliary neighbors such that the total weighted distance for all nodes in V is minimized.

The selection of the k best auxiliary neighbors depends on the manner in which the auxiliary neighbors will be used for routing query requests within the P2P network. For purposes of clarity, assume that there is no change in the underlying routing policy of the P2P network and, further, that the auxiliary neighbors are used for routing in a manner that is similar to the manner in which the core neighbors are used for routing. These assumptions enable the auxiliary neighbor selection algorithms described herein to be incrementally deployed in a large P2P system without any associated implementation issues.

As described herein, two implementation issues associated with use of auxiliary neighbors include: (1) maintenance of the query frequency statistics and (2) maintenance of the selected auxiliary neighbors.

With respect to maintenance of the access frequency information at a peer node, the access frequency information may be maintained in many ways. In one embodiment, if the number of queried nodes is large (i.e., such that the node cannot maintain access frequency information for all peer nodes of the P2P network), the node can store the top-n most frequently queried nodes. In this embodiment, the value of n may be chosen based on storage limitations at the node. In such embodiments, the smaller value of n also reduces the computation overhead of selecting the auxiliary neighbors for the node (however, a resulting tradeoff is that the resulting set of auxiliary neighbors selected for the node may be suboptimal because some of the peer nodes are ignored during the auxiliary neighbor selection process).

With respect to maintenance of the selected auxiliary neighbors, entries in the routing table may become stale (e.g., due to churn in the system. For example, as existing nodes leave, entries of the routing table may point to nodes that have already left the system. For example, as new nodes join, the first node at a particular distance may change). In one embodiment, in order to overcome such issues, each node may periodically ping its core and auxiliary neighbors in order to identify stale entries of the routing table. In one such embodiment, the stale entries can be marked in the routing table or removed from the routing table. As described herein, these entries will be fixed the next time the auxiliary neighbor selection algorithm is executed (e.g., which may be periodically, a periodically in response to an event since previous selection of the auxiliary neighbors, and the like, as well as various combinations thereof).

As described herein, the auxiliary neighbor selection functions of the present invention may be implemented within a Pastry P2P system. In Pastry, a query for an item with identifier I is forwarded to a neighbor whose identifier has the longest prefix match with I. In order to compute the optimal set of k auxiliary neighbors that minimizes (I), the distance between any two nodes u and v is estimated in terms of number of hops. In one embodiment, the value b−l may be used as an estimate of this distance, where l is the length of the longest prefix match. For example, the distance between the four-bit identifiers 1011 and 1111 is three because l in this case is just one. It may be noted that value b−l is a reasonable estimate in the absence of any additional information since, in the worst case, while routing and “fixing” each bit at a time, the number of hops incurred can go up to b−l . Thus, this would be the upper bound in steady state. As the source node does not have knowledge of the exact position of every node, it is reasonable to use this upper bound as a measure of the actual distance. It also may be noted that the choice of k pointers remains the same even if the distances are scaled by a constant factor.

In one embodiment, the auxiliary neighbor selection algorithm for Pastry is an O(nk²b) dynamic algorithm. In one embodiment, the auxiliary neighbor selection algorithm for Pastry is an optimal O(nkb) greedy algorithm. In such embodiments, n represents the number of distinct peers for which the source node (i.e., the node on which the auxiliary neighbor selection algorithm is being executed) has seen queries from peer nodes of the P2P system. In one embodiment, an incremental auxiliary neighbor selection algorithm may be implemented for adaptively maintaining the set of auxiliary neighbors in response to different conditions (e.g., as nodes leave/join the P2P system, as node popularities change, and the like, as well as various combinations thereof). In one further embodiment, such algorithms may be adapted to support QOS-aware routing (e.g., to handle queries that must be answered within a certain number of hops).

In one embodiment, in which the present invention is implemented within a Pastry system, the auxiliary neighbor selection algorithm may be implemented as an O(nk²b) dynamic algorithm.

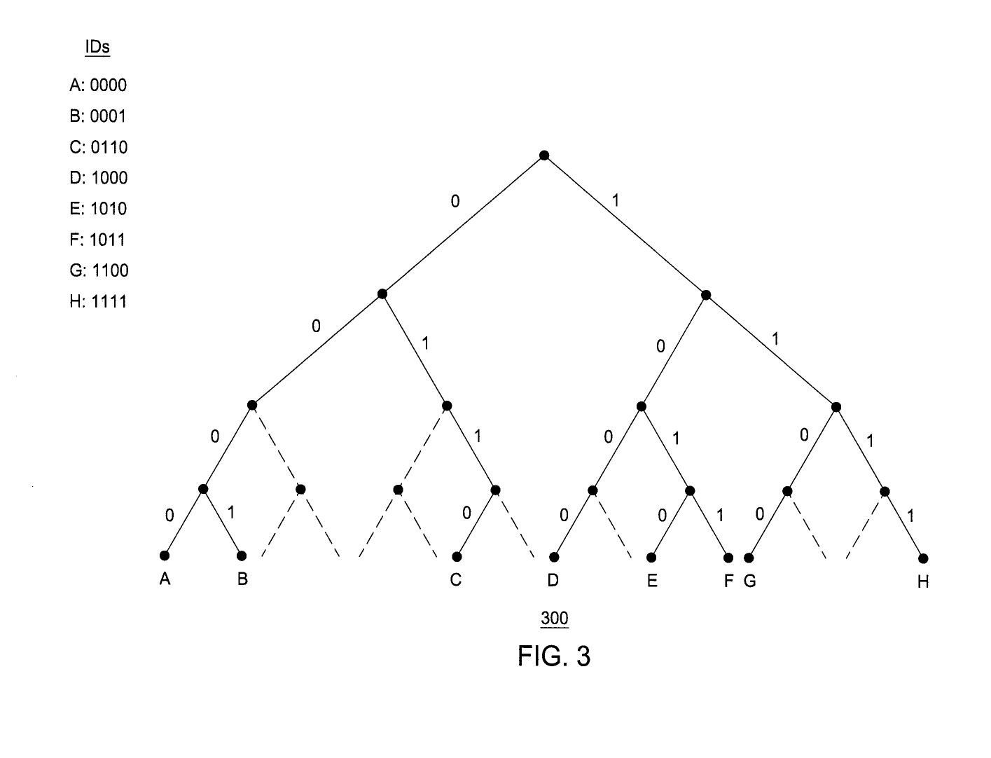

In one embodiment, given the identifiers of the nodes in V, a tree T is constructed using the identifiers. The tree T is constructed as a binary tree of the node identifiers (denoted as a trie). In the tree T, each node in V corresponds to a leaf of tree T, such that the path from the root of tree T to the leaf determines the identifier of the node (and, thus, the terms “nodes” and “leaf vertices” may be used interchangeably to refer to the corresponding Pastry nodes). An exemplary tree T is depicted in FIG. 3.

In one embodiment, the O(nk²b) auxiliary neighbor selection algorithm utilizes properties of vertices of tree T in order to select auxiliary neighbors. A first property of the vertices of tree T is that the distance between two Pastry nodes is equal to the height of the common ancestor of their corresponding leaf vertices (where the height of a vertex is its distance to the closest leaf in the tree). A second property of the vertices of tree T is that if a leaf in a subtree Tₐ has been chosen as a neighbor (core or auxiliary), then queries for any leaf in subtree Tₐ are always routed via some leaf in subtree Tₐ.

In one embodiment, the problem of selecting the optimal set of auxiliary neighbors is equivalent to selecting the k leaves in tree T such that the sum of weighted distances for all of the leaves is minimized. By the first property of the vertices of tree T, the weighted distance for a leaf v is the product of fᵥ and the height of the closest common ancestor with any of its core or auxiliary neighbors. The implementation of the algorithm may be better understood with respect to additional notation, which follows.

In one embodiment, let Tₐ denote the subtree rooted at vertex a, and let Lₐ and Rₐ denote the left and right subtrees of Tₐ. Further, let Leafset(Tₐ) denote the set of all leaves in the subtree Tₐ. Further, let F(Tₐ) represent the sum of the frequencies of all of the leaves of Tₐ (i.e., F(Tₐ)=Σ_{(εLeafset(Ta)} fₗ). Further let C(Tₐ,S) denote the cost contributed (within Tₐ) by the leaves of Tₐ is S (⊂Leafset(Tₐ)) is chosen as the set of auxiliary neighbors. In this embodiment, C(Tₐ,S) may be obtained recursively, as follows (where (S∩Lₐ) is used as shorthand notation for (S∩Leafset(Lₐ)) and I_{A}=1 if A is true and I_{A}=0 otherwise):

C(Tₐ, S)=TERM 1+TERM 2, where:

TERM 1=C(Lₐ, S∩Lₐ)+F(Lₐ)·I_{((N}_{_{S}}_{∩S)∩L}_{₀}₀₎ (Eq. 1)

TERM 2=C(Rₐ, S∩Lₐ)+F(Rₐ)·I_{((N}_{_{S}}_{∩S)∩R}_{_{d}}₌₀₎

In general, the intuition behind this equation is that S includes some leaf vertices from left subtree Lₐ and some leaf vertices from right subtree Rₐ. By the second property of the vertices of tree T, the number of pointers placed in the left subtree of vertex a does not affect the cost contributed by the right subtree of vertex a, and, similarly, the number of pointers placed in the right subtree of vertex a does not affect the cost contributed by the left subtree of vertex a. Thus, the cost may be split according to the split of the pointers between subtree Lₐ and subtree Rₐ.

The additional term F(Lₐ)·I_{((N}_{_{S}}_{•S)∩L}_{ₙ}₌₀₎ may be explained by noting that this term is equal to F(Lₐ) only if there is no neighbor (core or auxiliary) in left subtree Lₐ, and it is 0 otherwise. If there is no neighbor in left subtree Lₐ, then there is an additional cost of one for each leaf in left subtree Lₐ due to the edge between vertex a and left subtree Lₐ (which is essentially one extra bit that needs to be fixed while routing). On the other hand, if there is a neighbor in left subtree Lₐ, then the edge between vertex a and left subtree Lₐ is part of the common prefix between the neighbor and any leaf in left subtree Lₐ, and does not contribute to the cost. A similar argument applies to the right subtree Rₐ.

In this embodiment, let C(Tₐ,j) represent the minimum cost with j pointers (i.e., C(Tₐ,j)=min_{|S|=j} C(Tₐ,S)), such that C(Tₐ,j) may be obtained recursively. The recurrence follows from the recurrence C(Tₐ,S) by noting that j pointers in subtree Tₐ can be split between left subtree Lₐ and right subtree Rₐ in j+1 different ways: (i,j+1), where i ranges from 0 to j. Further, it may be noted that the indicator function in recurrence C(Tₐ,j) essentially remains the same as the indicator function in recurrence C(Tₐ,S) (i.e., I_{(i=̂(N}_{_{S}}_{∩L}_{ₐ}₌₀₎₎ is one if and only if there is no neighbor (core or auxiliary) in left subtree Lₐ; similarly, I_{(i=0̂(N}_{_{S}}_{∩R}_{ₐ}₌₀₎₎ is one if and only if there is no neighbor (core or auxiliary) in right subtree Rₐ). The recurrence C(Tₐ,j) may be obtained recursively, as follows:

$$C ( {T}_{a} , j ) = {min}_{0 \leq i \leq j} \{ TERM 1 + TERM 2 \} , where \text{:} \\ TERM 1 = C ( {L}_{a} , i ) + F ( {L}_{a} ) \cdot {I}_{i = 0 ⋀ {N}_{s} ⋂ {L}_{a} = 0 ) )} \\ TERM 2 = C ( {R}_{a} , j - 1 ) + F ( {R}_{a} ) \cdot {I}_{i = j ⋀ {N}_{s} ⋂ {R}_{a} = 0 ) )} \qquad ( Eq . 2 )$$

The recurrence C(Tₐ,j) may be solved by traversing the tree bottom-up. In order to compute the optimal set of neighbors, each vertex maintains a set of leaves that corresponds to cost C(Tₐ,j) for all 1≦j≦k. This implies that the storage cost at each vertex is O(k²) and, thus, total storage is O(nk²b) as there are at most O(nb) vertices in the tree. Furthermore, the computational complexity is also O(nk²b) because there are at most O(nb) vertices at which computation is done, and at vertex a, the recurrence C(Tₐ,j) for all 0≦j≦k requires O(k) computations.

In one embodiment, in which the present invention is implemented within a Pastry system, the auxiliary neighbor selection algorithm may be implemented as an optimal O(nkb) greedy algorithm.

In this embodiment, as described with respect to the O(nk²b) dynamic algorithm, given the identifiers of the nodes in V, a tree T is constructed using the identifiers. The tree T is constructed as a binary tree of the node identifiers (denoted as a tree). In the tree T, each node in V corresponds to a leaf of tree T, such that the path from the root of tree T to the leaf determines the identifier of the node (and, thus, the terms “nodes” and “leaf vertices” may be used interchangeably to refer to the corresponding Pastry nodes). An exemplary tree T is depicted in FIG. 3.

In one embodiment, the O(nkb) greedy algorithm utilizes an additional property of vertices of tree T in order to select auxiliary neighbors. The O(nkb) greedy algorithm uses the property that at any vertex of the tree T, the optimal set of j−1 auxiliary neighbor pointers must be a subset of the optimal set of j auxiliary neighbors. This property may be exploited in order to simplify the recurrence C(Tₐ,j) described herein with respect to the O(nk²b) dynamic algorithm. Specifically, in this embodiment, let l denote the number of neighbor pointers chosen from left subtree Lₐ in the optimal set of j−1 auxiliary neighbors at vertex a, such that recurrence C(Tₐ,j) may be simplified as:

$$C ( {T}_{a} , j ) = {min}_{i ∈ \{ l , l + 1 \}} \{ TERM 1 + TERM 2 \} , where \text{:} \\ TERM 1 = C ( {L}_{a} , i ) + F ( {L}_{a} ) \cdot {I}_{i = 0 ⋀ {N}_{s} ⋂ {L}_{a} = 0 ) )} \\ TERM 2 = C ( {R}_{a} , j - 1 ) + F ( {R}_{a} ) \cdot {I}_{i = j ⋀ {N}_{s} ⋂ {R}_{a} = 0 ) )} \qquad ( Eq . 3 )$$

In this embodiment, assuming that we know that the optimal set of j−1 pointers is split between left subtree Lₐ and right subtree Rₐ as (t,j−l−1), i.e., l pointers in left subtree Lₐ and j−l−1 points in right subtree Rₐ. Then, since the optimal set of j pointers is a superset of the optimal set of j−1 pointer, the optimal set of j pointers is split between left subtree Lₐ and right subtree Rₐ as either (l, j−1) or (l+1, j−l−1). Further, it may be noted that, given the optimal sets at left subtree Lₐ and right subtree Rₐ, simplified recurrence C(Tₐ,j) enables selection of the optimal set of k auxiliary neighbors at Tₐ using only O(k) computations. Thus, overall complexity of the O(nkb) greedy algorithm is O(nkb) and, further, the total storage requirement is also O(nkb) because each vertex needs to store only k pointers.

In one embodiment, an incremental auxiliary neighbor selection algorithm may be implemented for adaptively maintaining the set of auxiliary neighbors in response to different conditions (e.g., as nodes leave/join the P2P system, as node popularities change, and the like, as well as various combinations thereof).

In this embodiment, note that the optimal set of k neighbors is computed for every subtree of tree T (as described with respect to the O(nkb) greedy algorithm) and, further, that as long as nothing changes in a subtree the computed set of auxiliary neighbors remains optimal. In other words, if a change associated with a node is detected (e.g., a node is deleted or inserted, the popularity of the node changes, and the like), then the only vertices affected are the vertices whose subtree includes the node for which there is an associated change. This observation enables modification of the O(nkb) greedy algorithm to form an algorithm adapted for re-computing the optimal set of auxiliary neighbors in response to such events.

In one such embodiment, the O(nkb) greedy algorithm is modified to take an additional parameter I (the identifier of the affected peer node). In this embodiment, each vertex of the tree T determined whether node I is a leaf within its subtree. If a vertex determines that node I is not a leaf within its subtree, it returns the previously-computed values of the cost and pointer, and does not invoke the auxiliary neighbor selection algorithm on its children. If a vertex determines that node I is a leaf within its subtree, new computations are performed only on the vertices along the path corresponding to node I. The running time of this incremental auxiliary neighbor selection algorithm is O(bk) because the processing cost at each vertex in the tree T is O(k), and the number of vertices at which the optimal set of auxiliary neighbors is re-computed is at most b.

In one embodiment, such Pastry-based auxiliary neighbor selection algorithms may be extended to handle multiple query classes. For example, as QOS-sensitive applications (e.g., VoIP, IPTV, VOD, and the like) continue to gain prominence, real-time applications may require certain queries to be answered within a fixed time period and, thus, within a certain number of hops. In such an environment, where at least some of the queries must be answered within a threshold period of time (and, thus, there are multiple classes of queries), the minimization problem may be considered to be a constrained version of the original minimization problem described herein: given per-node access frequencies and delay bounds, the goal becomes to identify a set of auxiliary neighbors that minimize the average lookup time while ensuring that per-node delay bounds (required for QOS-sensitive applications) are met.

In one such embodiment, the O(nkb) greedy algorithm may be adapted to handle such per-node delay bounds to support multiple query classes. The delay bounds translate to restrictions on the vertices of the tree T. If a node has a delay bound of x, then the subtree of height x that contains the corresponding leaf must have an auxiliary neighbor. In one embodiment, this constraint may be added to the O(nkb) greedy algorithm by marking such subtrees, and modifying the O(nkb) greedy algorithm to select at least one auxiliary neighbor pointer from such subtrees. This modification can be implemented without any increase in complexity.

As described herein, the auxiliary neighbor selection functions of the present invention may be implemented within a Chord P2P system. In Chord, all peer nodes are placed in a clockwise fashion on a ring in increasing order of their identifiers. The Chord routing policy is as follows: for a query to node v at s, the next hop is the neighbor of s closest to v, and between s and v in the clockwise direction. Here, node identifiers refer to the nodes. Thus, the next hop chosen is: arg min_{ωεN}, {(v−w) mod 2^{b}}. The choice of core neighbors ensures that, in the steady state, a query originating at node u and destined for node v requires a maximum of dᵤᵥ hops, where dᵤᵥ is a distance defined as: dᵤᵥ=1+└log((v−u) mod 2^{b})┘. The distance dᵤᵥ is an upper bound in the steady state, and does not make any assumptions about actual positions of the nodes (i.e., dᵤᵥ is equivalent to the position of the leftmost “1” in (v−u) mod2^{b}, and unlike Pastry, this distance function is not symmetric). For Chord-based auxiliary neighbor selection algorithms described herein, an assumption is made that auxiliary neighbor selection is performed at the node with an identifier of “zero” (i.e., zero in all b bits of the identifier). This node is referred to as the zero node. Further, the m^{th} immediate successor of the zero-node in the clockwise direction on the ring is referred to as node m.

In one embodiment, the auxiliary neighbor selection algorithm for Chord is an O(n²k) dynamic algorithm. In one embodiment, the auxiliary neighbor selection algorithm for Pastry is an optimal O(n(b+k log b) log n) dynamic algorithm. In such embodiments, n represents the number of distinct peers for which the source node (i.e., the node on which the auxiliary neighbor selection algorithm is being executed) has seen queries from peer nodes of the P2P system. In one embodiment, such algorithms may be adapted to support QOS-aware routing (e.g., to handle queries that must be answered within a certain number of hops).

In one embodiment, in which the present invention is implemented within a Chord system, the auxiliary neighbor selection algorithm may be implemented as an O(n²k) dynamic algorithm.

In one such embodiment, let No denote the set of core neighbors of the zero-node. Further, let C_{I}(m) be the cost of optimally placing/auxiliary neighbor pointers when only the m immediate successors of the zero-node are considered. Then, considering the nodes in increasing order of the node identifiers, the cost C_{I}(m) may be represented as follows:

$${C}_{l} ( m ) = {min}_{1 \leq j \leq m} [ {C}_{l - 1} ( j - 1 ) + s ( j , m ) ] , \\ where s ( j , m ) = {\sum }_{l = j + 1}^{m} {f}_{l} d ( \{ j \} ⋃ {N}_{0} , l ) \qquad ( Eq . 4 )$$

Thus, the minimum cost that can be obtained using k auxiliary neighbor pointers is Cₖ(n). In the equation for cost C_{I}(m), s(j,m) denotes the cost of routing queries to all nodes between the j^{th} and the m^{th} successor when there is a pointer to the j^{th} successor and no auxiliary pointers between the j^{th} and the m^{th} successor. Further, if j is the largest identifier among the auxiliary neighbors of the zero-node that have identifiers smaller than that of m, then all queries to a node with an identifier between that of j and m are routed through j or an existing neighbor from the set N₀ that is closer. On the other hand, queries to nodes 1, 2, . . . , j−1 cannot use the pointer at j for routing and, thus, the cost contributed by such nodes is recursively handled by C_{I-}1(j−1). Thus, minimizing over all possible j gives the cost C_{I}(m).

In one embodiment, recurrence C_{I}(m) may be solved in two steps. In the first step, s(j,m) is computed for all pairs (j,m) such that j<m. In the second step, the equation for cost C_{I}(m) is solved using a dynamic programming algorithm that has two nested “for” loops, and which takes as input each s(j,m) computed in the first step. In this embodiment, the complexity of the first step is O(n²) and the complexity of the second step is O(n²k), giving an overall complexity of O(n²k). The recurrence C_{I}(m) may be solved in other ways for use in selecting the set of auxiliary neighbors for a peer node.

In one embodiment, in which the present invention is implemented within a Chord system, the auxiliary neighbor selection algorithm may be implemented as an O(n(b+k log b) log n) dynamic algorithm.

In one embodiment, this algorithm is an extension of the O(n²k) dynamic algorithm. In one such embodiment, the O(n²k) dynamic algorithm is extended such that it scales with the number of nodes as O(n log n). In this embodiment, however, there are two obstacles to such providing such an improved algorithm. The first obstacle is that tabulating all of the possible O(n²) values of s(j,m) for solving the recurrence C_{I}(m) is O(n²). The second obstacle is that, given the values of s(j,m), solving the recurrence C_{I}(m) using a naïve dynamic algorithm is O(n²k).

In this algorithm, the first obstacle may be overcome by avoiding tabulation of all of the O(n²) values of s(j,m) a priori. Rather, suitable data structures may be constructed using O(bn log n) operations such that s(j,m) (for any j and m) can be computed using O(log b) operations. In this algorithm, the second obstacle may be overcome by using an adapted version of the equation for s(j,m), described hereinbelow, which may be adapted to solve the recurrence C_{I}(m) using O(kn log n) operations (assuming the values of s(j,m) are known or can be computed in O(l) time).

In one embodiment, data structures are maintained to compute s(j,m) for a given (j,m) pair. In describing such data structures, let F(j) denote the cumulative frequencies until node j (i.e., (Fⱼ)=Σ_{1≦j}fₗ).

In one embodiment, consider the case in which there is no core neighbor of the zero-node between node j and node m. In this case, s(j,m) may be expressed as follows:

$$s ( j , m ) = {\sum }_{r = 1}^{{d}_{jm}} r \times ( \begin{matrix}total frequency of nodes \\ at distance r and \\ identifiers numerically less \\ than identifiers of m\end{matrix} ) \qquad ( Eq . 5 )$$

Using this expression of s(j,m), let pⱼ(r) denote the node that is farthest from j among all of the nodes that are at distance at most r from j. Then, the total frequency of nodes at a distance r is simply F(pⱼ(r))−F(pⱼ(r−1)). Thus, the expression of s(j,m) above may be rewritten as follows (which provides an indication of the minimal data structures that need to be maintained in order to compute s(j,m) for a given (j,m) pair):

$$s ( j , m ) = {\sum }_{r = 1}^{{d}_{jm} - 1} \{ r ( F ( {p}_{j} ( r ) ) - F ( {p}_{j} ( r - 1 ) ) + {d}_{jm} ( F ( m ) - F ( {p}_{j} ( {d}_{jm} - 1 ) ) ) \} \qquad ( Eq . 6 )$$

Using this updated expression of s(j,m), it becomes apparent that the following information needs to be maintained: (1) points pⱼ(r), for all r≦d(j,N₀), and (2) cumulative frequencies F(j). Since distance is upper-bounded by b, the space requirement for the points pⱼ(r) (1≦j<n, 1≦r≦b) is at most O(nb). Thus, each pⱼ(r) can be computed using a binary search over the n ordered points and, since there are at most b such points for all j, overall complexity for computing the points pⱼ(r) is O(nb log n). Further, cumulative frequencies F(j) can be computed using O(n) operations.

In another embodiment, consider the case in which there is a core neighbor of the zero-node between node j and node m. In this case, let j₁, j₂, . . . , jᵣ be the core neighbors of the zero-node that lie between j and m. In this case, s(j,m) may be expressed as follows:

s(j,m)=s(j₁,j₂−1)+s(j₁,j₂−1)+ . . . +s(jᵣ,m) (Eq. 7)

This expression of s(j,m) follows because a pointer that is placed at node j can only help a node i such that there is no core neighbor between node j and node i. Otherwise, routing in Chord dictates that queries to node i are routed through the closest core neighbor that lies between node j and node i. This expression of s(j,m) provide a two step procedure which may be implemented to compute s(j,m) using the pⱼ(k) values and the cumulative frequencies F(j). In the first step, the core neighbors between which m lies are determined using a binary search. In the second step, Equation 6 is used to compute each of the terms in Equation 7.

Thus, the necessary data structures can be constructed using O(nb log n) operations, and can be used to compute s(j,m) for any (j,m) pair using O(log b) operations. Further, in order to improve the O(n²k) dynamic algorithm, a result from Equation 6 may be used to solve the following recurrence f(j) using O(n log n) computations (assuming that the function w(i,j) is concave):

$$f ( j ) = {min}_{1 \leq i \leq j - 1} [ f ( i ) + w ( i , j ) ] , ∀ j \leq n \qquad ( Eq . 8 )$$

Further, it may also be shown that s(j,m) is concave, and, although the recurrence f(j) is two-dimensional, the algorithms of Equation 6 may be extended to obtain an O(nk log n) algorithm for solving Equation 4. Thus, the recurrence C_{I}(m) (from Equation 4) can be solved using O(n(b+k log b) log n) operations and O(n(b+k)) space.

In one embodiment, as with Pastry-based auxiliary neighbor selection algorithms, such Chord-based auxiliary neighbor selection algorithms may be extended to handle multiple query classes. As described herein with respect to Pastry, for Chord-based auxiliary neighbor selection algorithms, the minimization problem may be considered to be a constrained version of the original minimization problem described herein: given per-node access frequencies and delay bounds, the goal becomes to identify a set of auxiliary neighbors that minimize the average lookup time while ensuring that per-node delay bounds (required for QOS-sensitive applications) are met. Thus, the Chord-based auxiliary neighbor selection algorithms may be adapted to support multiple query classes (and, thus, multiple QOS classes).

As described herein, auxiliary neighbor caching functions of the present invention may be extended to support multiple QOS classes. In one such embodiment, at least one of the QOS classes may require a query to be answered within a guaranteed worst-case query time). In one embodiment, for example, a guaranteed worst-case query time may be provided for high-priority queries (i.e., queries associated with a high-priority QOS-class) and average query time may be minimized for low-priority queries (i.e., queries associated with a low-priority QOS-class). In such embodiment, any number of QOS classes may be supported (using any number of priority levels).

As described herein, the auxiliary neighbor caching functions of the present invention may be utilized in many different applications, such as naming services queries (e.g., performing Domain Name Service (DNS), performing queries for content (e.g., queries for files, songs, movies, and the like), and the like, as well as various combinations thereof. As described herein, the auxiliary neighbor caching functions of the present invention may be extended to support multiple QOS classes (such that guaranteed worst-case query times can be supported), and, thus, may also be used in QOS-sensitive applications, such as voice-over-IP (VOIP), IP television (IPTV), video on demand (VOD), and the like, as well as various combinations thereof. The auxiliary neighbor caching functions of the present invention may be utilized in any other application(s) utilizing peer-to-peer networks.

Although primarily depicted and described herein with respect to using auxiliary neighbors within peer-to-peer systems implemented using specific peer-to-peer protocols (namely, Pastry and Chord), auxiliary neighbors may be used within peer-to-peer systems implemented using various other peer-to-peer protocols. For example, auxiliary neighbor selection techniques described herein for Pastry can be applied to other peer-to-peer protocols, such as Tapestry, PGrid, and the like. For example, auxiliary neighbor selection techniques described herein for Chord can be applied to other peer-to-peer protocols, such as SkipGraph and the like. The auxiliary neighbor selection techniques described herein for Pastry can be applied to any other P2P systems.

Although primarily depicted and described herein as a standalone technique for improving query response latency in peer-to-peer systems, use of auxiliary neighbors may be used in conjunction with various other techniques for improving query response latency in peer-to-peer networks. For example, the auxiliary neighbor selection techniques described herein may be used in conjunction with item replication replications techniques, item caching techniques, and the like, as well as various combinations thereof.

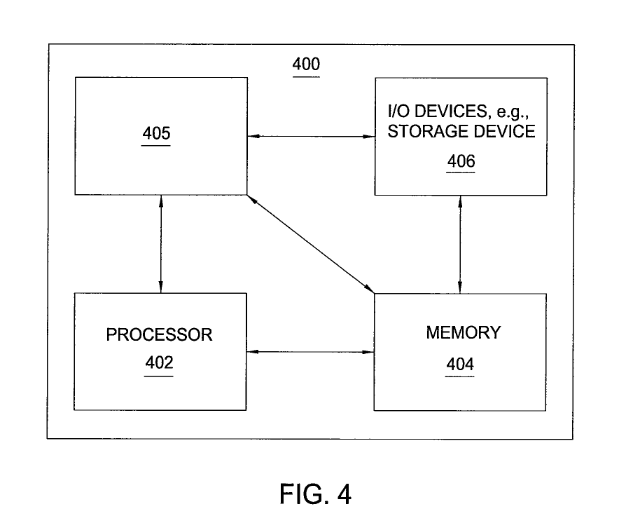

FIG. 4 depicts a high-level block diagram of a general-purpose computer suitable for use in performing the functions described herein. As depicted in FIG. 46, system 400 comprises a processor element 402 (e.g., a CPU), a memory 404, e.g., random access memory (RAM) and/or read only memory (ROM), an auxiliary neighbor selection module 405, and various input/output devices 406 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the functions/elements described herein may be implemented in software and/or in a combination of software and hardware, e.g., using application specific integrated circuits (ASIC), a general purpose computer or any other hardware equivalents. In one embodiment, the present auxiliary neighbor selection process 405 can be loaded into memory 404 and executed by processor 402 to implement the functions as discussed above. As such, auxiliary neighbor selection process 405 (including associated data structures) described herein can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for augmenting a neighbor list of a target peer node of a peer-to-peer network, wherein the neighbor list comprises a plurality of core neighbors, the method comprising:
maintaining query frequency information associated with each of a plurality of peer nodes of the peer-to-peer network;
selecting at least one of the peer nodes of the peer-to-peer network as an auxiliary neighbor using the query frequency information; and
updating the neighbor list to include the at least one auxiliary neighbor.

2. The method of claim 1, wherein, for each peer node, the query frequency information is indicative of a number of times that the peer node has queried the target peer node in a given period of time.

3. The method of claim 1, wherein the at least one peer node selected as the at least one auxiliary neighbor is selected in a manner tending to minimize an average query lookup time for the target peer node.

4. The method of claim 1, wherein the steps of selecting and updating are performed in response to an event, wherein the event comprises at least one of a peer node leaving the peer-to-peer network, a peer node joining the peer-to-peer network, and a query frequency value associated with a peer node changing by a threshold amount.

5. The method of claim 1, wherein the at least one auxiliary neighbor is selected in a manner for supporting queries from a plurality of quality-of-service classes.

6. The method of claim 5, wherein the quality-of-service classes comprise at least one quality-of-service class having a required worst-case query response time.

7. The method of claim 1, wherein selecting the at least one peer node as an auxiliary neighbor comprises:
constructing a tree comprising a plurality of leaves, where each leaf of the tree is associated with one of the peer nodes of the peer-to-peer network; and
selecting at least one of the leaves of the tree in a manner tending to minimize a sum of weighted distance values associated with the peer nodes;
wherein the at least one of the leaves of the tree is selected by traversing the tree in a bottom-up manner;
wherein the weighted distance for each peer node is a product of a query frequency value for the peer node and a height of a closest common ancestor with any core neighbor or auxiliary neighbor associated with the peer node.

8. The method of claim 7, wherein an optimal set of j-1 auxiliary neighbors is a subset of j auxiliary neighbors for any value of j such that a computational complexity of selecting the at least one auxiliary neighbor scales linearly with a number of auxiliary neighbors selected.

9. The method of claim 1, wherein selecting the at least one peer node as an auxiliary neighbor comprises:
computing, for each of a plurality of pairs of peer nodes (j,m), a cost of routing queries to peer nodes between the j^{th} successor of the target peer node and the m^{th} successor of the target peer node when there is a pointer to the j^{th} successor of the target peer node and no auxiliary pointers between the j^{th} successor of the target peer node and the m^{th} successor of the target peer node; and
solving, using the computed costs for the pairs of peer nodes (j,m), a cost equation in a manner for selecting the at least one peer node as the auxiliary neighbor, wherein the cost equation is indicative of a cost of placing the at least one auxiliary neighbor for the target peer node.

10. The method of claim 1, wherein selecting the at least one peer node as an auxiliary neighbor comprises:
computing, for each of a plurality of pairs of peer nodes (j,m), a cost of routing queries to peer nodes between the j^{th} successor of the target peer node and the m^{th} successor of the target peer node, wherein for each pair of peer nodes the associated cost is computed using a weighted distance value and a cumulative query frequency value; and
solving a cost equation in a manner for selecting the at least one peer node as the auxiliary neighbor, wherein the cost equation is indicative of a cost of placing the at least one auxiliary neighbor for the target peer node, wherein the cost equation is solved using the computed costs for the pairs of peer nodes (j,m) and, for each value of m, information indicative of a set of optimal auxiliary neighbors for a set of m−1 nodes adapted for use in identifying optimal auxiliary neighbors for a set of m nodes.

11. A computer-readable medium storing a software program which, when executed by a computer, causes the computer to perform a method for augmenting a neighbor list of a target peer node of a peer-to-peer network, wherein the neighbor list comprises a plurality of core neighbors, the method comprising:
maintaining query frequency information associated with each of a plurality of peer nodes of the peer-to-peer network;
selecting at least one of the peer nodes of the peer-to-peer network as an auxiliary neighbor using the query frequency information; and
updating the neighbor list to include the at least one auxiliary neighbor.

12. The computer-readable medium of claim 11, wherein, for each peer node, the query frequency information is indicative of a number of times that the peer node has queried the target peer node in a given period of time.

13. The computer-readable medium of claim 11, wherein the at least one peer node selected as the at least one auxiliary neighbor is selected in a manner tending to minimize an average query lookup time for the target peer node.

14. The computer-readable medium of claim 11, wherein the steps of selecting and updating are performed in response to an event, wherein the event comprises at least one of a peer node leaving the peer-to-peer network, a peer node joining the peer-to-peer network, and a query frequency value associated with a peer node changing by a threshold amount.

15. The computer-readable medium of claim 1, wherein the at least one auxiliary neighbor is selected in a manner for supporting queries from a plurality of quality-of-service classes.

16. An apparatus for augmenting a neighbor list of a target peer node of a peer-to-peer network, wherein the neighbor list comprises a plurality of core neighbors, the apparatus comprising:
mean for maintaining query frequency information associated with each of a plurality of peer nodes of the peer-to-peer network;
means for selecting at least one of the peer nodes of the peer-to-peer network as an auxiliary neighbor using the query frequency information; and
means for updating the neighbor list to include the at least one auxiliary neighbor.

17. The apparatus of claim 16, wherein, for each peer node, the query frequency information is indicative of a number of times that the peer node has queried the target peer node in a given period of time.

18. The apparatus of claim 16, wherein the at least one peer node selected as the at least one auxiliary neighbor is selected in a manner tending to minimize an average query lookup time for the target peer node.

19. The apparatus of claim 16, wherein the means for selecting and the means for updating are adapted to perform the respective functions of selecting and updating in response to an event, wherein the event comprises at least one of a peer node leaving the peer-to-peer network, a peer node joining the peer-to-peer network, and a query frequency value associated with a peer node changing by a threshold amount.

20. The apparatus of claim 16, wherein the at least one auxiliary neighbor is selected in a manner for supporting queries from a plurality of quality-of-service classes.
